(19) United States
(12) Patent Application Publication
(10) Pub. No.: US 2011/0064340 A1
(43) Pub. Date: Mar. 17, 2011

(54) METHOD AND APPARATUS FOR STABILIZING A SQUEEZE FILM DAMPER FOR A ROTATING MACHINE

(76) Inventors: Loc Quang Duong, San Diego, CA (US); Xiaolan Hu, San Diego, CA (US)

(21) Appl. No.: 12/561,474

(22) Filed: Sep. 17, 2009

(51) Int. Cl. F16C 27/00

(52) U.S. Cl. 384/99; 384/535

(57) ABSTRACT

A rotor bearing system for a rotating machine includes a housing having a bore that provides an inner surface. A bearing assembly is disposed within the bore and includes an outer surface. An annular cavity is provided radially between the outer surface and the inner surface. At least one protrusion extends radially outwardly from at least one of the inner and outer surfaces to an apex and into the annular cavity. A radial gap is arranged between the apex and the opposite surface from which the protrusion extends. In the disclosed example, the annular cavity is filled with an oil to provide a squeeze film damper between the housing and the bearing assembly. The protrusions exert a hydrodynamic preload on the bearing assembly, which reduces vibration during operation of the rotating machine.

### BACKGROUND

High speed rotating machines, such as auxiliary power units, may be subject to undesired vibrations during operation. For example, one type of auxiliary power unit may experience relatively high synchronous vibrations at speeds below the operating speed during transitional speed excursions. Such vibrations over time can result in the loss of engine structural integrity, including broken oil tubes, rear bearing turbine assembly failure and damage to the rotor assembly.

A squeeze film damper has been used at an interface between a housing and a bearing assembly to dissipate energy associated with “whirling” of the rotor bearing system. The squeeze film damper is intended to reduce rotor vibrations and bearing forces. A whirling condition exists when a rotational axis of the rotor orbits about the intended rotational axis provided by the housing. Despite the damping provided by the squeeze film, the eccentric movement or vibration of the rotor axis about the housing axis can cause damage or failure of rotor bearing system components.

### SUMMARY

A rotor bearing system is disclosed for a rotating machine. The rotor bearing system includes a housing having a bore that provides an inner surface. A bearing assembly is disposed within the bore and includes an outer surface. An annular cavity is provided radially between the outer surface and the inner surface. At least one protrusion extends radially outwardly from at least one of the inner and outer surfaces to an apex and into the annular cavity. A radial gap is arranged between the apex and the opposite surface from which the protrusion extends. In the disclosed example, the annular cavity is filled with an oil to provide a squeeze film damper between the housing and the bearing assembly. The protrusions exert a hydrodynamic preload on the bearing assembly, which reduces vibration during operation of the rotating machine.

These and other features of the disclosure can be best understood from the following specification and drawings, the following of which is a brief description.

### BRIEF DESCRIPTION OF THE DRAWINGS

FIG. 1 is a cross-sectional view of an example auxiliary power unit.

FIG. 2 is an enlarged cross-sectional view of a rotor bearing system illustrated in circle 2 of FIG. 1.

FIG. 3 is a cross-sectional view taken along line 3-3 in FIG. 2.

FIG. 4 is an enlarged cross-sectional view of a portion of the rotor bearing system with a squeeze film damper with its size exaggerated.

FIG. 5 is a partial top elevational view of an example outer cage.

FIG. 6 is a partial cross-sectional view of the bearing assembly with a rolling bearing element centered relative to a housing.

### DETAILED DESCRIPTION

An example auxiliary power unit (APU) 10 is illustrated in FIG. 1. The APU 10 includes a compressor 12 supported for rotation on a shaft 18. The axis A1 is centrally located relative to a housing 22 within which the shaft 18 is supported for rotation by a bearing assembly 20. A combustor 14 receives compressed air from the compressor 12 and supplies combusted gases to turbines 16, which rotate the shaft 18. The shaft 18 may include one or more shaft portions and is rotatable about an axis A2.

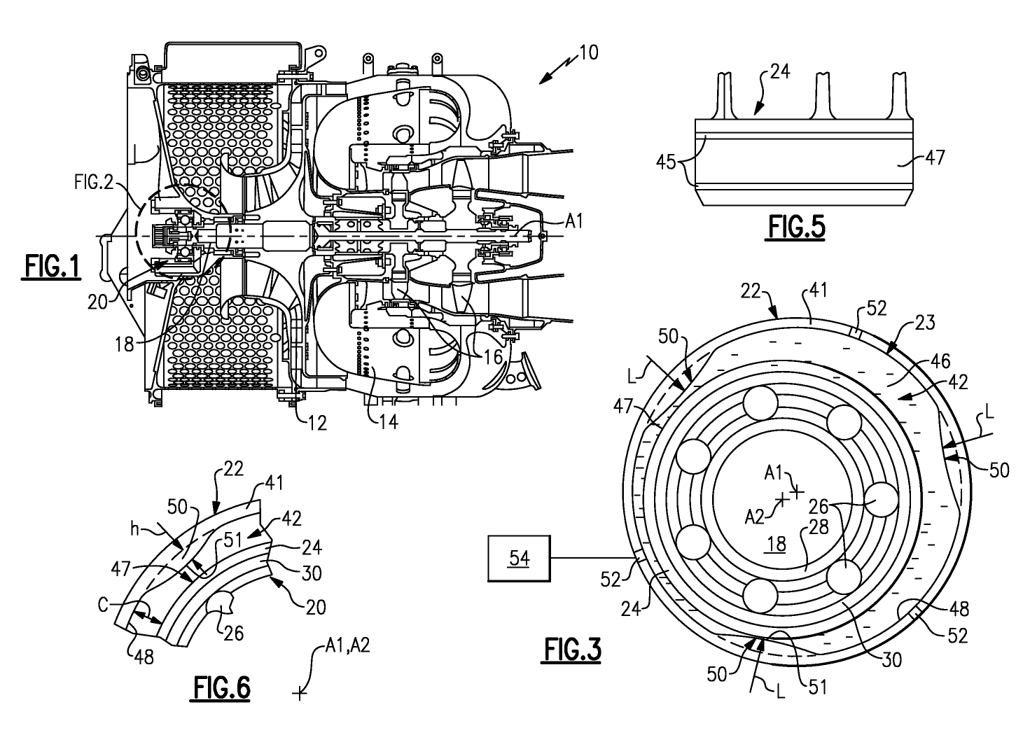

Referring to FIG. 2, the bearing assembly 20 includes an outer cage 24 having a radially extending annular flange 25 that is secured to the housing 22 by a fastening element 26. The outer cage 24 is received within a bore 23 in the housing 22, which provides the axis A1.

A rolling bearing element 27 is pressed into the outer cage 24. In one example, the rolling bearing element 27 is a ball bearing, although other bearings, such as needle bearings, can be used. The rolling bearing element 27 includes rolling elements 32 circumferentially retained by a bearing cage 34 and secured between inner and outer races 28, 30. A retainer 36, such as a circlip, is used to axially retain the outer race 30 relative to the outer cage 24. The shaft 18 is received in a press-fit relationship with the inner race 28. The inner race 28 is axially retained relative on the shaft 18 with a collar 38 that is secured to the shaft 18 by a fastener 40.

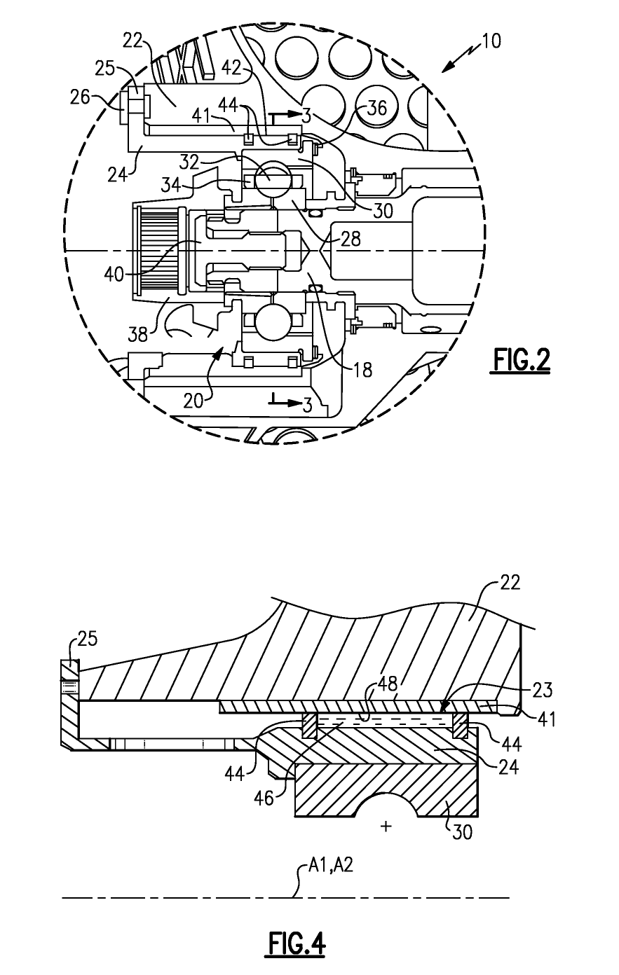

Referring to FIGS. 3-5, an annular cavity 42 is provided at the interface between the outer cage 24 and the housing 22. In the example illustrated, the housing 22 receives a liner 41 in a press-fit relationship providing an inner surface 48 that surrounds an outer surface 47 of the outer cage 24. The outer cage 24 includes annular grooves 45 (FIG. 5) receiving axially spaced apart piston rings 44 (FIGS. 2 and 4) with the outer surface 47 axially arranged between the piston rings 44.

The housing 22, liner 41, outer cage 24, piston rings 44 and outer race 30 are rotationally fixed relative to one another. The shaft 18 and inner race 28 are rotationally fixed relative to one another.

The housing 22 provides the axis A1 about which it is desirable to rotate the shaft 18. However, due to vibration of the bearing assembly 20 during operation of the APU 10, the shaft 18 may rotate about the axis A2 that is offset from the axis A1, best shown in FIG. 3. The axis A2 may orbit about the axis A1 and in part vibration to various components of the APU 10. Accordingly, a squeeze film 46 is provided in the annular cavity 42 between the inner and outer surfaces 48, 47 to damp the eccentric movement of the bearing assembly 20 within the bore 23. Circumferentially spaced holes 52, in fluid communication with a fluid source 54, are provided in the liner 41 to supply a fluid, such as oil, to the annular cavity 42.

Circumferentially spaced lobes or protrusions 50 extend radially inwardly into the annular cavity 42 from at least one of the inner and outer surfaces 48, 47, which are generally cylindrical in shape. Each protrusion 50 is arranged circumferentially between a pair of holes 52. In the example shown, three protrusions 50 are circumferentially spaced from one another equally and extend from the inner surface 48 to an apex 51. It should be understood that protrusions may extend from the inner surface 47 instead or additionally. Moreover, more or fewer than three lobes can be used. The apexes 51 do not contact the opposite surface, the inner surface 47 in the example, when the axes A1, A2 are coaxial with one another (FIG. 6). The protrusions 50 create a hydrodynamic preload L (FIG. 3) on the bearing assembly 20, which damps the eccentric movement of the bearing assembly 20 within the annular cavity 42. More specifically, the lubricant in the annular cavity 42 is displaced thus creating hydrodynamic pressure that acts on the outer cage 24 (preload L) to damp its relative radial movement between the axes.

The bearing assembly 20 is shown centered in the housing 22 in FIG. 6 such that the axes A1, A2 are coaxial with one another. In this position, a clearance c between the outer surface 47 from which the protrusion 50 does not extend (solid line illustrating the outer surface 48) and an area of the inner surface 48 is approximately 0.003-0.005 inch (0.076-0.127 mm) in one example application. The clearance c varies based upon the given application. The height h of the protrusion 50 extends from the outer surface (shown from dashed line) into the annular cavity 42 less than one half the distance of the clearance c. In one example, the height h is less than or equal to 0.3 c. As a result, a radial gap (c-h) is provided between the apexes 51 (only one shown in FIG. 6) and the inner surface 47 with the axes A1, A2 coaxial with one another.

Although example embodiments have been disclosed, a worker of ordinary skill in this art would recognize that certain modifications would come within the scope of the claims. For that reason, the following claims should be studied to determine their true scope and content.

What is claimed is:

1. A rotor bearing system for a rotating machine comprising:
a housing including a bore providing an inner surface;
a bearing assembly disposed in the bore and including an outer surface and having an annular cavity radially between the outer surface and the inner surface; and
at least one protrusion extending radially outwardly from at least one of the inner and outer surfaces to an apex and into the annular cavity, and a radial gap between the apex and the opposite surface from which the protrusion extends.

2. The rotor bearing system according to claim 1, wherein the housing includes a liner providing the bore.

3. The rotor bearing system according to claim 2, wherein the liner includes the at least one protrusion.

4. The rotor bearing system according to claim 1, comprising multiple protrusions circumferentially spaced from one another.

5. The rotor bearing system according to claim 4, wherein the housing includes holes provided circumferentially between the protrusions and configured to be in fluid communication with a fluid source for providing a fluid to the annular cavity.

6. The rotor bearing system according to claim 1, wherein the bearing assembly includes a cage secured to the housing, and supporting a bearing rolling element, the bearing rolling element supporting a shaft for rotation about an axis.

7. The rotor bearing system according to claim 6, wherein the bearing rolling element is a ball bearing.

8. The rotor bearing system according to claim 1, comprising a shaft supported by the bearing assembly, wherein the housing provides an first axis and the shaft provides a second axis, the axes being radially offset from one another during a vibration mode, the protrusions configured to generate a hydrodynamic preload protrusions onto the bearing assembly for damping relative movement between the axes.

9. The rotor bearing system according to claim 1, comprising axially spaced apart piston rings arranged between the housing and bearing assembly, the at least one protrusion provided axially between the piston rings, the piston rings providing enclosing the annular cavity.

10. The rotor bearing system according to claim 9, wherein the bearing assembly includes an outer cage, the cage including axially spaced apart annular grooves receiving the piston rings.

11. The rotor bearing system according to claim 1, wherein the apex is spaced from the at least one of the inner and outer surfaces a radial height, the radial height less than the radial clearance with the first and second axes coaxial with one another.

12. The rotor bearing system according to claim 11, wherein the radial height is less than or equal to 30% of the radial clearance.

13. The rotor bearing system according to claim 12, wherein the radial clearance is approximately equal to 0.003-0.005 inch.

14. A rotor bearing system comprising:
structure having a generally cylindrical surface providing at least three circumferentially spaced protrusions each extending radially to an apex, the apexes extending from the circumferential surface less than half of 0.003-0.005 inch.

15. The rotor bearing system according to claim 14, wherein the member is a housing including lubrication holes, each protrusion arranged between a pair of lubrications holes.

16. The rotor bearing system according to claim 15, wherein the housing includes a liner, the liner providing the holes and the protrusions, and configured to receive a bearing assembly.

17. A method of damping a rotating machine comprising:
providing an annular cavity between a bearing assembly and a housing with protrusions extending from one of the bearing assembly and housing and spaced from the other of the bearing assembly and housing;
orbiting the bearing assembly about an axis provided by the housing; and
generating a hydrodynamic preload with the protrusions onto the bearing assembly.
